(19) United States
(12) Patent Application Publication
(10) Pub. No.: US 2026/0246534 A1
(43) Pub. Date: Aug. 20, 2026

(54) OPTICAL AMPLIFICATION RELAY DEVICE, OPTICAL TRANSMISSION SYSTEM AND OPTICAL AMPLIFICATION RELAY METHOD

(71) Applicant: NTT, Inc., Tokyo (JP)

(72) Inventors: Shimpei SHIMIZU, Musashino-shi (JP); Takayuki KOBAYASHI, Musashino-shi (JP); Yutaka MIYAMOTO, Musashino-shi (JP); Akira KAWAI, Musashino-shi (JP)

(73) Assignee: NTT, Inc., Tokyo (JP)

(21) Appl. No.: 19/156,960

(22) PCT Filed: Feb. 20, 2023
(86) PCT No.: PCT/JP2023/005962

§ 371 Date: Aug. 15, 2025

(51) Int. Cl. H04B 10/294; H04B 10/25; H04B 10/291; H04B 10/60

(52) U.S. Cl. CPC H04B 10/2941; H04B 10/25; H04B 10/2916; H04B 10/60

(57) ABSTRACT

An optical transmission system includes: a gain equalization unit that adjusts a power spectrum of an optical signal based on an adjustment spectrum having characteristics complementary to characteristics of a gain spectrum; an amplifier that amplifies the power spectrum adjusted based on the adjustment spectrum based on the gain spectrum; and a receiving unit that performs demodulation processing on the optical signal or phase conjugate light of the amplified power spectrum. The adjustment spectrum has constant characteristics regardless of the power spectrum and bandwidth of the optical signal input to the gain equalization unit. The gain equalization unit adjusts the power spectrum of the optical signal by distributed Raman amplification or lumped Raman amplification.

### TECHNICAL FIELD

The present invention relates to an optical amplification relay device, an optical transmission system and an optical amplification relay method.

### BACKGROUND ART

In recent years, communication traffic has been exponentially increasing with the start of operation of the 5th Generation Mobile Communication System and the spread of rich content such as high-resolution moving images. Therefore, there is a demand to continuously increase the communication capacity of optical transmission systems. In optical transmission, the transmission bandwidth of optical signals is broadened, which can improve the transmission capacity per optical fiber, and various studies are being conducted to realize the transmission of ultra-wideband wavelength division multiplexing signals.

In a transmission method using long-distance optical fibers, optical amplifiers are used to compensate for optical losses that occur in optical signals transmitted through the optical fibers. In such a transmission method, the transmission band of the optical transmission system is limited according to the amplification band of the optical amplifier.

There are optical amplifiers that use optical fibers doped with rare-earth elements. For example, an erbium-doped fiber amplifier (EDFA) is a representative rare-earth-doped optical amplifier. The erbium-doped fiber amplifier has an amplification band of about 4 THz in the C-band or L-band, where the transmission loss in the optical fiber is small. This band is a band of wavelengths (frequencies) that are generally used in optical transmission using long-distance optical fibers.

The amplification band may be shifted by changing the rare-earth element doped in the optical fiber. The transmission band may also be expanded by arranging heterogeneous amplifiers with shifted amplification bands in parallel with each other. However, in these cases, the gain is reduced, and noise increases in bands other than the C-band and L-band. In addition, considering the cost of the optical transmission system, the operation of the optical transmission system, and the excessive optical loss caused by dividing the band of the optical signal into many band components, it is desirable to amplify the optical signal in a wide band by a single optical amplifier.

Therefore, optical parametric amplifiers (OPAs) have attracted attention. Optical parametric amplifiers amplify input optical signals by utilizing the nonlinear optical effect of a second-order nonlinear optical medium or a third-order nonlinear optical medium. The second-order nonlinear optical medium is, for example, lithium niobate. The third-order nonlinear optical medium is, for example, an optical fiber.

The amplification band of an optical parametric amplifier depends on the phase matching characteristics of the nonlinear optical medium used as an amplification medium. If the amplification medium is designed to achieve wideband phase matching characteristics, it becomes possible to amplify a wideband optical signal that exceeds the amplification band of an erbium-doped fiber amplifier.

In addition, by designing the amplification medium, it is possible to amplify optical signals in various wavelength bands other than the C-band and the L-band. In a second-order nonlinear optical medium, where the second harmonic is required for the pumped light for the optical parametric amplification process, the difference between the frequency of the optical signal to be amplified and the frequency of the pumped light is large. As a result, the difference in the effective refractive index for each band component becomes large, and it is not easy to design a medium that satisfies the phase matching condition over a wide range of frequencies.

However, a technique called quasi-phase matching (QPM) can be used to achieve wideband phase matching characteristics. In quasi-phase matching, a periodically poled structure is used. A periodically poled structure is a structure in which regions in which the sign of the nonlinear susceptibility is inverted are formed periodically and alternately in the propagation axis direction of a nonlinear optical medium.

In periodically poled lithium niobate (PPLN), unwanted nonlinear optical effects are unlikely to occur. For this reason, in order to achieve both wideband characteristics, gain, and low noise, a configuration using periodically poled lithium niobate as the amplification medium is promising. NPD 1 shows the possibility of realizing amplified repeater transmission with a wide bandwidth exceeding 10 THz and an amplification gain of 15 dB. NPL 1 uses an optical parametric amplifier that uses a periodically poled lithium niobate waveguide.

In an optical parametric amplifier, phase conjugate light (idler light) of the amplified optical signal is generated at a frequency symmetrical with respect to the center frequency of the amplification band. In order to transmit an optical signal, at least one of the original optical signal (optical signal before amplification) and the idler light is transmitted. For this reason, optical components not used in transmission are removed without being extracted by a band-pass filter (BPF) after the optical signal is amplified.

When idler light is extracted as an optical signal to be used in transmission, the optical parametric amplifier also functions as an optical phase conjugate converter (see NPD 2) or a wavelength converter (see PTD 1). In this way, one of the characteristics of an optical parametric amplifier is that it functions not only as a simple optical amplifier but also as various optical signal processing units.

### Citation List

### Patent Document

PTD 1: Japanese Patent Application Publication No. 2020-086031

### Non Patent Documents

NPD 1: T. Kobayashi et al., “Wide-band Inline-amplified WDM Transmission Using PPLN-based Optical Parametric Amplifier”, IEEE J. Lightwave Technol., vol. 39, no. 3, pp. 787-794, February 2021.
NPD 2: T. Umeki et al., “Simultaneous nonlinearity mitigation in 92×180-Gbit/s PDM-16QAM transmission over 3840 km using PPLN-based guard-band-less optical phase conjugation”, Optics Express, 24, 15, 16945-16951 (2016).

### SUMMARY OF INVENTION

### Technical Problem

In an amplified repeater transmission, the optical amplifier needs to compensate for the transmission loss of the optical signal in the entire band used for the optical transmission. Even in a single-span transmission, a sufficient amplification gain must be ensured in order to ensure the signal-to-noise ratio required for receiving the optical signal in the entire band used for the optical transmission. In the following, the amplification band of an optical amplifier having a predetermined amplification gain is referred to as the “effective amplification band”.

The phase matching band of a nonlinear optical medium that determines the amplification band of an optical parametric amplifier is determined according to the wavelength dependence of the refractive index of the nonlinear optical medium. The wavelength dependence of the refractive index can be changed by adjusting the parameter design and temperature during the manufacturing of the nonlinear optical medium.

When the temperature is adjusted so that phase matching is optimized in the band near the center frequency, the gain spectrum of the optical parametric amplifier has a flat top shape. On the other hand, when the phase matching state changes due to the temperature adjustment of the nonlinear optical medium, the gain becomes lower near the center frequency, and the gain becomes higher outside the center frequency. This makes it possible to widen the effective amplification band. When the temperature is adjusted in the direction opposite to the direction in which the effective amplification band is widened, the shape of the gain spectrum changes so that the band in which the gain is flat near the center frequency becomes narrower.

Gain saturation is also one of the issues with optical parametric amplifiers. The region of the input signal light power that causes saturation is called the “saturation region”. Due to the high-speed response of the optical parametric amplification process, the gain does not fluctuate with respect to dynamic multiplexing and demultiplexing of wavelength channels, so the optical parametric amplifier can keep the output power per channel constant. However, the high-speed response of the optical parametric amplification process causes nonlinear signal distortion in the optical signal when the optical parametric amplification operates in the gain saturation region.

In the process of optical parametric amplification, if the power of the pumped light is sufficiently stronger than the power of the input optical signal, the gain is constant relative to the power of the input optical signal, and the power of the output optical signal responds linearly to the power of the input optical signal. In addition, the pumped light is used to amplify the input optical signal, and the amplification gain decreases due to the attenuation of the pumped light.

Furthermore, due to the high-speed response of the optical parametric amplifier, the amplification gain increases and decreases due to the fact that it follows the change over time in the power of the modulated input optical signal. As a result, the power of the output optical signal shows a nonlinear response to the power of the input optical signal. This phenomenon is called gain saturation.

In an amplifier with a slow response such as an erbium-doped fiber amplifier, amplification gain occurs relative to the time average of the power of the optical signal, even when the amplifier operates in the saturation region. As a result, the change over time in the amplification gain relative to the input optical signal is not large, so the input optical signal is amplified linearly. In this case, only the limitation of the power of the output optical signal is an issue.

In contrast, when an optical parametric amplifier with a high-speed response operates in the saturation region, the amplification gain changes according to the change over time in the power of the input optical signal. As a result, in an optical signal modulated in the amplitude direction, a gain corresponding to the amplitude level of the modulation symbol occurs, and nonlinear amplitude distortion occurs in the optical signal. Therefore, the operating range (input/output range) of the optical parametric amplifier must be determined, taking into account not only the upper limit of the power of the output optical signal but also the signal deterioration caused by nonlinear distortion due to gain saturation.

In addition, in amplified repeater transmission, gain equalization is performed to correct the gradient of the shape of the gain spectrum of the optical amplifier. When the shape of the transmission loss spectrum of a transmission line is flat, the power spectrum of the optical signal output from the optical amplifier is attenuated so that the shape of the power spectrum of the optical signal output from the optical amplifier is also flat.

When the transmission loss spectrum of a transmission line has wavelength dependence, an optical signal with a wavelength that has a large transmission loss is transmitted with a strong power corresponding to the transmission loss so that the optical signal-to-noise ratio (OSNR) of the transmitted optical signal is constant regardless of the wavelength channel.

However, when gain equalization is performed on the amplified optical signal, it is necessary to greatly attenuate the power of the optical signal at wavelengths where the gain of the optical amplifier is high. Here, since the power of the optical signal output from the amplifier is limited by gain saturation, greatly attenuating the optical signal by gain equalization means that the optical power that can be practically used is further limited.

In particular, when the temperature of the waveguide is adjusted to widen the amplification band of the optical parametric amplifier, the shape of the gain spectrum has a gradient. The power spectrum of the optical signal in the wavelength band with high gain is attenuated so that the optical signal-to-noise ratio of the transmitted optical signal in the wavelength band with high gain due to the gradient becomes equal to the optical signal-to-noise ratio of the transmitted optical signal in the band with low gain. For this reason, the power of the output optical signal is limited as the wavelength band is widened according to the temperature of the waveguide, and the gradient of the shape of the gain spectrum becomes steeper. However, there is a problem that nonlinear signal distortion caused by gain saturation in the optical parametric amplifier cannot be suppressed.

In view of the above circumstances, the present invention aims to provide an optical amplified repeater, an optical transmission system, and an optical amplified repeating method capable of suppressing nonlinear signal distortion caused by gain saturation in an optical parametric amplifier.

### Solution to Problem

An aspect of the present invention provides an optical amplified repeater including: a gain equalization unit that adjusts a power spectrum of an optical signal based on an adjustment spectrum having characteristics complementary to characteristics of a gain spectrum; an amplifier that amplifies the power spectrum adjusted based on the adjustment spectrum based on the gain spectrum.

Another aspect of the present invention provides an optical transmission system including: a gain equalization unit that adjusts a power spectrum of an optical signal based on an adjustment spectrum having characteristics complementary to characteristics of a gain spectrum; an amplifier that amplifies the power spectrum adjusted based on the adjustment spectrum based on the gain spectrum; and a receiving unit that performs demodulation processing on the optical signal or phase conjugate light of the amplified power spectrum.

Another aspect of the present invention provides an optical amplified repeating method executed by an optical transmission system, the method including: a step of adjusting a power spectrum of an optical signal based on an adjustment spectrum having characteristics complementary to characteristics of a gain spectrum; a step of amplifying the power spectrum adjusted based on the adjustment spectrum based on the gain spectrum; and a step of performing demodulation processing on the optical signal or phase conjugate light of the amplified power spectrum.

### Advantageous Effects of Invention

The present invention makes it possible to suppress nonlinear signal distortion caused by gain saturation in an optical parametric amplifier.

### BRIEF DESCRIPTION OF DRAWINGS

FIG. 1 A diagram showing an example of the configuration of an optical transmission system in a first embodiment.

FIG. 2 A diagram showing an example of the configuration of an optical parametric amplifier in the first embodiment.

FIG. 3 A diagram showing an example of the gain spectrum of a single optical parametric amplifier in the first embodiment.

FIG. 4 A diagram showing an example of the gain saturation characteristics of a single optical parametric amplifier in the first embodiment.

FIG. 5 A diagram showing an example of the relationship between the power of an optical signal before amplification and the signal quality of an amplified optical signal in the first embodiment.

FIG. 6 A diagram showing an example of the relationship between the power of an optical signal before amplification and the power of an amplified optical signal in the first embodiment.

FIG. 7 A flowchart showing an example of the operation of an optical transmission system in the first embodiment.

FIG. 8 A diagram showing an example of the configuration of an optical transmission system in a second embodiment.

FIG. 9 A diagram showing an example of the configuration of an optical transmission system in a third embodiment.

FIG. 10 A diagram showing an example of the relationship between the power of an optical signal before amplification and the signal quality of an amplified optical signal, taking into account the deterioration of the optical signal-to-noise ratio due to gain equalization in the third embodiment.

FIG. 11 A diagram showing an example of the configuration of an optical transmission system in a fourth embodiment.

FIG. 12 A diagram showing an example of the configuration of an optical transmission system in a fifth embodiment.

FIG. 13 A diagram showing an example of the configuration of an optical transmission system in a sixth embodiment.

FIG. 14 A diagram showing an example of the hardware configuration of a controller of an optical amplified repeater in each embodiment.

### DESCRIPTION OF EMBODIMENTS

Embodiments of the present invention will be described in detail with reference to the drawings.

### First Embodiment

In the first embodiment, an optical amplified repeating method (gain equalization method) for maximally utilizing the power of an optical signal (amplified optical signal) output from an optical parametric amplifier will be described.

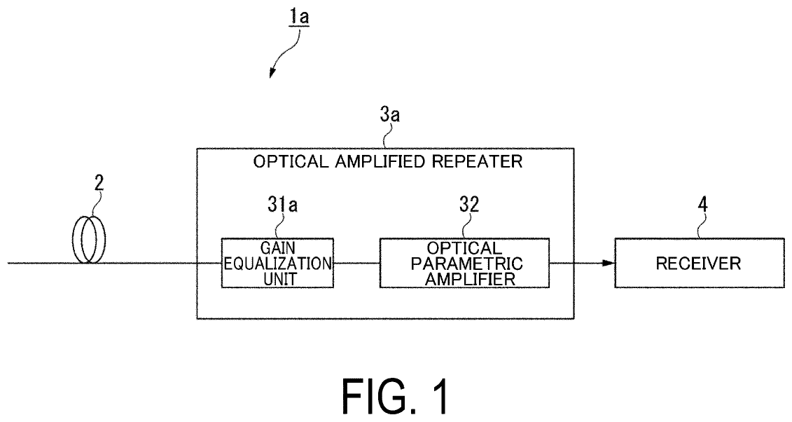

FIG. 1 shows an example of the configuration of an optical transmission system 1a in the first embodiment. The optical transmission system 1a is a system for transmitting an optical signal. The optical signal is generated, for example, based on a wavelength division multiplexed signal. The optical transmission system 1a includes a transmission line 2, an optical amplified repeater 3a, and a receiver 4. The transmission line 2 includes, for example, an optical fiber. The optical amplified repeater 3a includes a gain equalization unit 31a and an optical parametric amplifier 32. The gain equalization unit 31a is provided upstream of the optical parametric amplifier 32.

The transmission line 2 transmits the optical signal to the gain equalization unit 31a. The gain equalization unit 31a (loss medium) is a gain equalizer. The attenuation spectrum characteristics of the gain equalization unit 31a (the transmission characteristics of the gain equalization unit 31a) are the opposite characteristics (complementary characteristics) to the gain spectrum characteristics of the optical parametric amplifier. The attenuation spectrum characteristics are constant characteristics regardless of the power spectrum and bandwidth of the optical signal input to the gain equalization unit 31a. In other words, the attenuation spectrum characteristics do not change depending on the power spectrum and bandwidth of the optical signal.

The gain equalization unit 31a (adjustment unit) performs gain equalization in advance on the optical signal input to the optical parametric amplifier 32 using an attenuation spectrum (adjustment spectrum) that has the opposite characteristics to the characteristics of the gain spectrum of the optical parametric amplifier 32. The power of the optical signal before amplification is attenuated by gain equalization by the gain equalization unit 31a.

The gain equalization unit 31a inputs the optical signal that has been gain-equalized to the optical parametric amplifier 32. In other words, the gain equalization unit 31a inputs the optical signal whose power has been adjusted based on the attenuation spectrum to the optical parametric amplifier 32.

The optical parametric amplifier 32 performs optical parametric amplification on the optical signal whose power has been adjusted based on the attenuation spectrum. For example, in an amplifier such as an erbium-doped fiber amplifier, the shape of the gain spectrum depends on the power spectrum of the wavelength division multiplexed (WDM) signal input to the amplifier. On the other hand, in the optical parametric amplifier 32, if the power of the input optical signal is weak enough that gain saturation does not occur, the power spectrum of the optical signal input to the optical parametric amplifier 32 is linearly amplified based on the gain spectrum determined according to the phase matching state of the amplification medium, regardless of the shape of the power spectrum of the wavelength division multiplexed signal.

As a result, the power spectrum of the optical signal (amplified optical signal) output from the optical parametric amplifier 32 has a predetermined power spectrum shape (for example, a flat top shape) even if gain equalization is not performed after amplification. In addition, it becomes possible to maximally utilize the power of the optical signal output from the optical parametric amplifier 32.

The receiver 4 (receiving unit) receives the optical signal with the amplified power spectrum from the optical parametric amplifier 32. Instead of receiving the optical signal, the receiver 4 (receiving unit) may receive the idler light generated in the optical parametric amplifier 32 from the optical parametric amplifier 32. The receiver 4 executes demodulation processing on the received optical signal or the idler light.

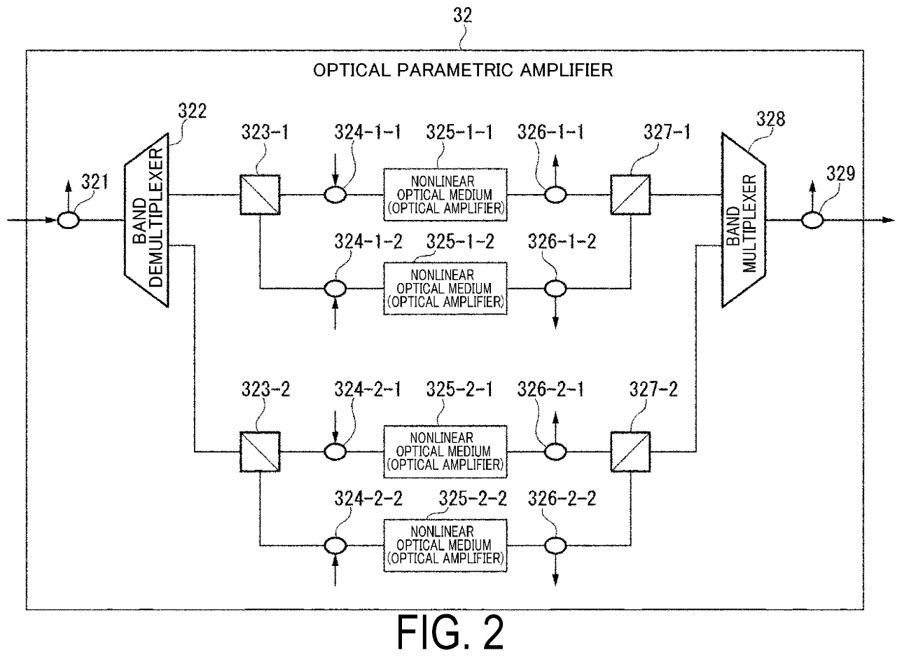

FIG. 2 is a diagram showing an example of the configuration of the optical parametric amplifier 32 in the first embodiment. The optical parametric amplifier 32 includes a monitor 321, a band demultiplexer 322, a plurality of polarization demultiplexers 323, a plurality of pumped light multiplexers 324, a plurality of nonlinear optical media 325, a plurality of pumped light demultiplexers 326, a plurality of polarization multiplexers 327, a band multiplexer 328, and a monitor 329.

The pumped light multiplexer 324 includes an optical device such as a wavelength multiplexing filter. The pumped light multiplexer 324 may include an optical device such as a dichroic mirror. The nonlinear optical medium 325 (optical amplifier) includes a periodically poled lithium niobate (PPLN) waveguide as an amplification medium. The pumped light demultiplexer 326 includes an optical device such as a wavelength multiplexing filter. The pumped light demultiplexer 326 may include an optical device such as a dichroic mirror.

The monitor 321 outputs the optical signal input to the optical parametric amplifier 32 to the band demultiplexer 322. The monitor 321 may output the monitor light of the optical signal input to the optical parametric amplifier 32 from the optical parametric amplifier 32.

The band demultiplexer 322 divides the band of the optical signal input to the optical parametric amplifier 32 into symmetric bands (first band and second band) with the center frequency of the amplification band as a boundary. This is because the optical signal output from the nonlinear optical medium 325 and the idler light are generated due to parametric amplification in the nonlinear optical medium 325. The band demultiplexer 322 outputs the first band optical signal to the polarization demultiplexer 323-1. The band demultiplexer 322 outputs the second band optical signal to the polarization demultiplexer 323-2.

The polarization demultiplexer 323-1 splits the first band optical signal into mutually orthogonal polarized components (first polarized component and second polarized component). This is because the process of optical parametric amplification in the nonlinear optical medium 325-1 has polarization dependence. The polarization demultiplexer 323-1 outputs the first polarized component to the pumped light multiplexer 324-1-1. The polarization demultiplexer 323-2 outputs the second polarized component to the pumped light multiplexer 324-1-2.

The pumped light multiplexer 324-1-1 multiplexes the first pumped light from a pumped light source (not shown) and the first polarized component. The pumped light multiplexer 324-1-2 multiplexes the second pumped light from a pumped light source (not shown) with the second polarized component.

The nonlinear optical medium 325-1-1 performs parametric amplification on the result of multiplexing the first polarized component and the first pumped light. The nonlinear optical medium 325-1-2 performs parametric amplification on the result of multiplexing the second polarized component and the second pumped light. The nonlinear optical medium 325 outputs the amplified optical signal and the idler light generated by the parametric amplification to the downstream pumped light demultiplexer 326.

The pumped light demultiplexer 326-1-1 splits the first pumped light from the result of the parametric amplification on the result of multiplexing the first polarized component and the first pumped light. The pumped light demultiplexer 326-1-1 outputs the first polarized component to the polarization multiplexer 327-1. The pumped light demultiplexer 326-1-2 splits the second pumped light from the result of the parametric amplification on the result of multiplexing the second polarized component and the second pumped light. The pumped light demultiplexer 326-1-2 outputs the second polarized component to the polarization multiplexer 327-1.

The first polarized component is input to the polarization multiplexer 327-1 from the pumped light demultiplexer 326-1-1. The second polarized component is input to the polarization multiplexer 327-1 from the pumped light demultiplexer 326-1-2. The polarization multiplexer 327-1 multiplexes the first polarized component and the second polarized component.

The polarization demultiplexer 323-2 operates in the same manner as the polarization demultiplexer 323-1. As a result of this operation, the polarization demultiplexer 323-2 outputs the third polarized component to the pumped light multiplexer 324-2-1. Furthermore, the polarization demultiplexer 323-2 outputs the fourth polarized component to the pumped light multiplexer 324-2-2.

The pumped light multiplexer 324-2-1 operates in the same manner as the pumped light multiplexer 324-1-1. The pumped light multiplexer 324-2-2 operates in the same manner as the pumped light multiplexer 324-1-2. The nonlinear optical medium 325-2-1 operates in the same manner as the nonlinear optical medium 325-1-1. The nonlinear optical medium 325-2-2 operates in the same manner as the nonlinear optical medium 325-1-2. The pumped light demultiplexer 326-2-1 operates in the same manner as the pumped light demultiplexer 326-1-1. The pumped light demultiplexer 326-2-2 operates in the same manner as the pumped light demultiplexer 326-1-2.

The polarization multiplexer 327-2 operates in the same manner as the polarization multiplexer 327-1. As a result of this operation, the polarization multiplexer 327-2 outputs the result of multiplexing the third polarized component and the fourth polarized component to the band multiplexer 328.

The result of multiplexing the first polarized component and the second polarized component is input to the band multiplexer 328 from the polarization multiplexer 327-1. The result of multiplexing the third polarized component and the fourth polarized component is input to the band multiplexer 328 from the polarization multiplexer 327-2. The band multiplexer 328 further multiplexes the result of multiplexing the first polarized component and the second polarized component and the result of multiplexing the third polarized component and the fourth polarized component.

The band multiplexer 328 removes the band that is not transmitted from the band of the optical signal and the band of the idler light in the multiplexing result of the polarized components using a filter in the band multiplexer 328. For example, the band multiplexer 328 extracts the optical signal from the optical signal and the idler light in the multiplexing result of the polarized components and removes the idler light that is not transmitted using the filter in the band multiplexer 328. The band multiplexer 328 may extract the idler light from the optical signal and the idler light in the multiplexing result of the polarized components and remove the optical signal that is not transmitted using the filter in the band multiplexer 328. By extracting the idler light, the optical parametric amplifier 32 can function as a phase conjugate converter or a wavelength converter.

The monitor 329 outputs the optical signal output from the band multiplexer 328 from the optical parametric amplifier 32. The monitor 329 may output the monitor light of the optical signal output from the band multiplexer 328 from the optical parametric amplifier 32.

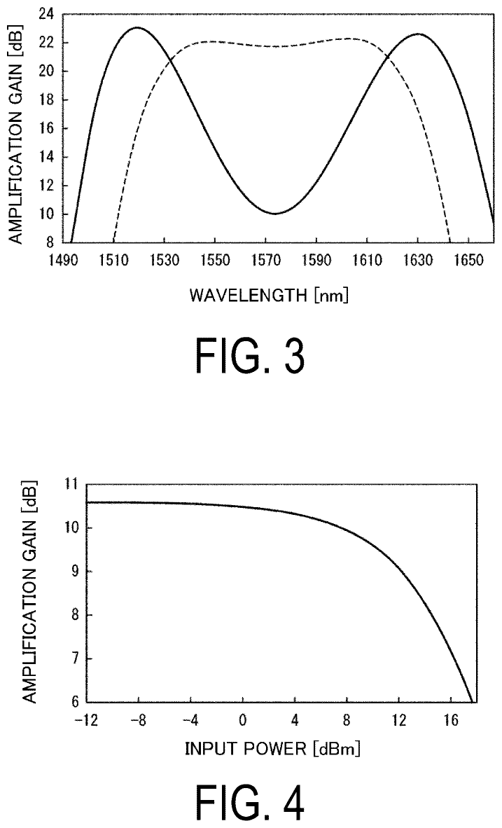

FIG. 3 is a diagram showing an example of the gain spectrum of the single optical parametric amplifier 32 in the first embodiment. The horizontal axis of FIG. 3 indicates the wavelength of the optical signal input to the single optical parametric amplifier 32. The vertical axis of FIG. 3 indicates the amplification gain of the optical signal.

The dashed line indicates the gain spectrum when phase matching is optimal for frequencies near the center frequency (center wavelength) of the amplification band. The solid line indicates the gain spectrum when phase matching is optimal for frequencies other than those near the center frequency (center wavelength) of the amplification band.

When the temperature of the waveguide is such that phase matching is optimal for frequencies other than those near the center frequency (center wavelength) of the amplification band, the gain spectrum has a flat top shape. In contrast, when the temperature of the waveguide is adjusted, phase matching becomes optimal at frequencies other than the center frequency (wavelengths far from the center wavelength), and the shape of the gain spectrum has a gradient according to the wavelength of the optical signal. By setting a frequency other than those near the center frequency as the optimal frequency as the phase matching condition, the amplification band is expanded, and it becomes possible to amplify a wider band wavelength division multiplexed signal.

FIG. 4 is a diagram showing an example of gain saturation characteristics of a single optical parametric amplifier 32 in the first embodiment. The horizontal axis of FIG. 4 indicates the power (input power) of the optical signal input to the single optical parametric amplifier 32. The vertical axis of FIG. 4 indicates the amplification gain of the optical signal.

In a region where the power of the input optical signal is weak, the attenuation of the pumped light associated with the optical parametric amplification process is small, and the amplification gain is constant regardless of the power of the input optical signal. Therefore, the amount of gain saturation is small. In contrast, in a region where the power of the input optical signal is strong, the attenuation of the pumped light associated with the optical parametric amplification process is large, and the stronger the power of the input optical signal, the smaller the amplification gain becomes. Therefore, in a region where the power of the input optical signal is strong, the stronger the power of the input optical signal, the greater the amount of gain saturation.

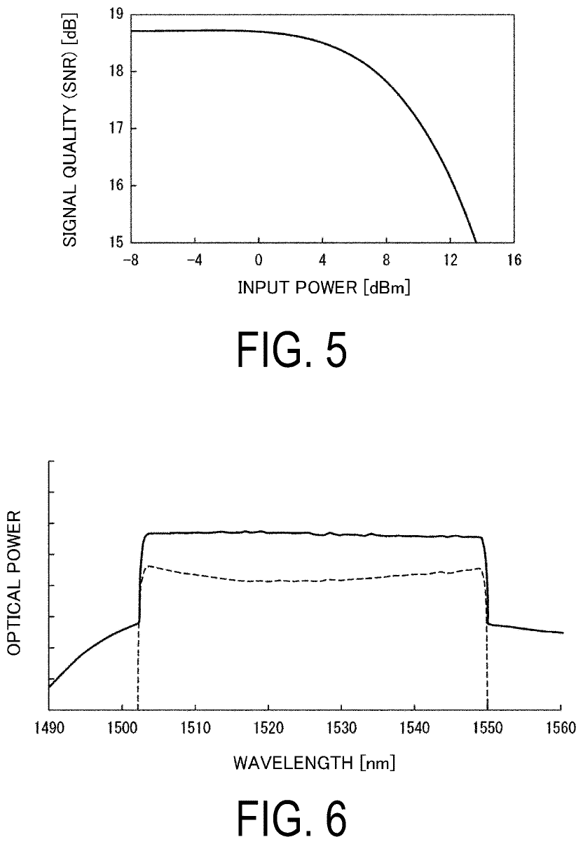

FIG. 5 is a diagram showing an example of the relationship between the power of the optical signal before amplification (power of the input optical signal) and the signal quality of the amplified optical signal in the first embodiment. The horizontal axis of FIG. 5 indicates the power (input power) of the optical signal input to the single optical parametric amplifier 32. The vertical axis of FIG. 5 indicates the signal quality of the amplified optical signal. The stronger the power of the input signal light, the greater the amount of gain saturation, and the greater the nonlinear amplitude distortion that occurs in the amplified optical signal, which deteriorates the signal quality.

FIG. 6 is a diagram showing an example of the relationship between the power of the optical signal before amplification (optical power) and the power of the amplified optical signal in the first embodiment. The horizontal axis of FIG. 6 indicates the wavelength of the optical signal (wavelength division multiplexed signal) input to the optical parametric amplifier 32. The vertical axis of FIG. 6 indicates the power of the optical signal (optical power).

The dashed line indicates the optical power of the optical signal before amplification (the optical signal input to the optical parametric amplifier 32). The solid line indicates the optical power of the amplified optical signal (the optical signal output from the optical parametric amplifier 32).

The attenuation spectrum of the gain equalization unit 31a has a shape that represents the opposite characteristics (complementary characteristics) to the characteristics of the gain spectrum of the optical parametric amplifier 32. In other words, the gradient of the shape of the attenuation spectrum of the gain equalization unit 31a and the gradient of the shape of the gain spectrum of the optical parametric amplifier 32 are complementary.

The power spectrum of the optical signal before amplification is attenuated by the gain equalization unit 31a. In other words, the power spectrum of the optical signal transmitted through the gain equalization unit 31a is adjusted based on the attenuation spectrum of the gain equalization unit 31a. The power of the amplified optical signal is amplified by the optical parametric amplifier 32 based on the gain spectrum of the optical parametric amplifier 32. As a result, the power spectrum of the amplified optical signal has a flat top shape.

Next, an example of the operation of the optical transmission system 1a will be described.

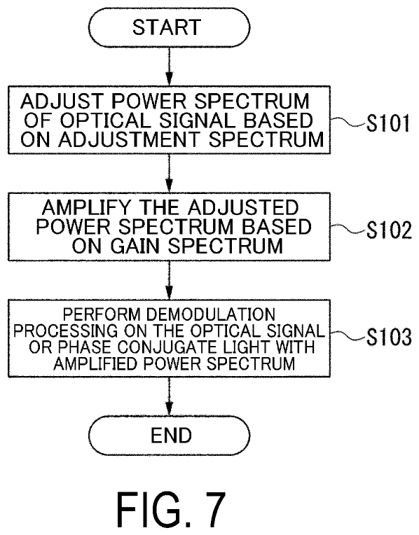

FIG. 7 is a flowchart showing an example of the operation of the optical transmission system 1a in the first embodiment. The gain equalization unit 31a adjusts the power spectrum of the optical signal based on the attenuation spectrum (step S101). The optical parametric amplifier 32 amplifies the adjusted power spectrum based on the gain spectrum (step S102). The receiver 4 executes demodulation processing on the optical signal or phase conjugate light having the amplified power spectrum (step S103).

As described above, the gain equalization unit 31a adjusts the power spectrum of the optical signal based on the attenuation spectrum (adjustment spectrum) having characteristics complementary to those of the gain spectrum. The optical parametric amplifier 32 amplifies the power spectrum adjusted based on the attenuation spectrum based on the gain spectrum. The receiver 4 (receiving unit) executes demodulation processing on the optical signal or phase conjugate light (idler light) with the amplified power spectrum.

In this way, the attenuation spectrum of the gain equalization unit 31a is designed so that the attenuation spectrum of the gain equalization unit 31a arranged upstream of the optical parametric amplifier 32 and the gain spectrum of the optical parametric amplifier 32 are complementary to each other.

This makes it possible to suppress nonlinear signal distortion caused by gain saturation in the optical parametric amplifier 32. The optical parametric amplifier 32 can efficiently repeat an optical signal (wideband wavelength division multiplexed signal) in the transmission line using output power limited by gain saturation and nonlinear amplitude distortion due to gain saturation.

### Second Embodiment

In the second embodiment, the main difference from the first embodiment is that another optical parametric amplifier is arranged upstream of the gain equalization unit arranged upstream of the optical parametric amplifier. In the second embodiment, the differences from the first embodiment will be mainly described.

If the gain equalization unit 31b (loss medium) arranged upstream of the optical parametric amplifier 32 simply equalizes the optical signal input from the transmission line 2, the power of the optical signal may be excessively attenuated, and the optical signal-to-noise ratio may deteriorate. In the second embodiment, therefore, one of the optical parametric amplifiers amplifies the optical signal before passing through the gain equalization unit 31b.

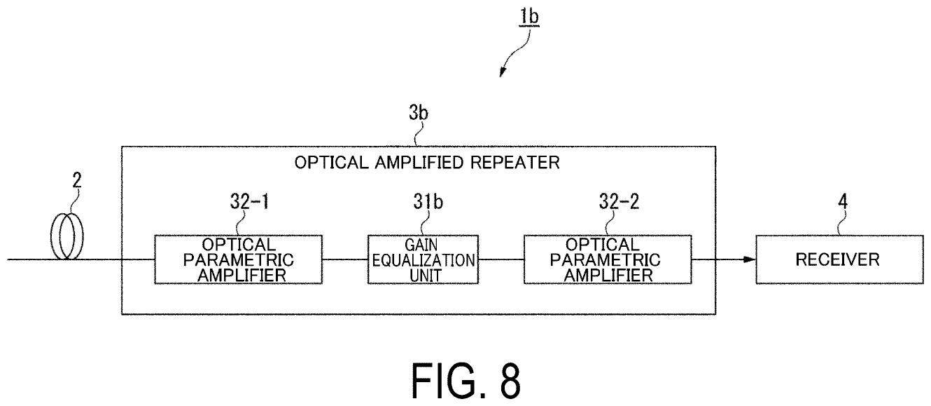

FIG. 8 is a diagram showing an example of the configuration of an optical transmission system 1b in the second embodiment. The optical transmission system 1b is a system that transmits an optical signal. The optical transmission system 1b includes a transmission line 2, an optical amplified repeater 3b, and a receiver 4. The optical amplified repeater 3b includes a gain equalization unit 31b, an optical parametric amplifier 32-1, and an optical parametric amplifier 32-2.

In the second embodiment, the gain equalization unit 31b is provided upstream of the optical parametric amplifier 32-2 and downstream of the optical parametric amplifier 32-1. The gain equalization unit 31b is a gain equalizer. The attenuation spectrum characteristics of the gain equalization unit 31b (loss medium) are opposite to the gain spectrum characteristics of the optical parametric amplifiers 32-1 and 32-2. The power of the optical signal before amplification by the optical parametric amplifier 32-2 is attenuated by the gain equalization unit 31b.

The amount of gain saturation in the optical parametric amplifier is determined according to the power of the output optical signal (output power). The output power of the optical parametric amplifier is determined by the product of the gains that amplify the power of the input optical signal in the optical parametric amplifier. Therefore, the weaker the power of the pumped light in the optical parametric amplification process, the lower the amplification gain. In addition, the amplification gain is also low when an optical parametric amplifier with low amplification efficiency is used. These can improve the power tolerance of the optical signal input to the optical parametric amplifier. However, in this case, the power (output power) of the optical signal output from the optical parametric amplifier decreases.

Therefore, in the second embodiment, the output power of the optical parametric amplifier 32-2 arranged downstream of the gain equalization unit 31b is larger than the output power of the optical parametric amplifier 32-1. Therefore, the optical signal input to the optical parametric amplifier 32-1 does not need to be gain-equalized in advance. The optical parametric amplifier 32-1 amplifies the input optical signal with a gain that is low enough that nonlinear distortion due to gain saturation does not occur in the input optical signal.

As described above, the gain equalization unit 31b is provided upstream of the optical parametric amplifier 32-2 and downstream of the optical parametric amplifier 32-1. The output power of the optical parametric amplifier 32-2 arranged downstream of the gain equalization unit 31b is larger than the output power of the optical parametric amplifier 32-1. This makes it possible to suppress nonlinear signal distortion caused by gain saturation in the optical parametric amplifier 32.

### Third Embodiment

The main difference between the third embodiment and the first embodiment is that a gain equalization unit is also arranged downstream of the optical parametric amplifier 32. In the third embodiment, the differences from the first embodiment will be mainly described.

In the first embodiment, the gain equalization unit 31a arranged upstream of the optical parametric amplifier 32 attenuates the power of the optical signal based on an attenuation spectrum having characteristics opposite to those of the gain spectrum of the optical parametric amplifier 32. As a result, the power of the optical signal output from the optical parametric amplifier 32 is maximized.

However, the noise of amplified spontaneous emission (ASE) emitted in association with the amplification of the optical signal in the optical parametric amplifier 32 becomes relatively larger as the power of the optical signal input to the optical parametric amplifier 32 becomes weaker. For this reason, the optical signal-to-noise ratio deteriorates in channels located in a band with large attenuation in the gain spectrum (near a wavelength with high gain).

In this way, there is a trade-off between the power limitation due to the gain saturation characteristics of the optical parametric amplifier 32 and the deterioration of the optical signal-to-noise ratio due to gain equalization. In the third embodiment, therefore, not only a gain equalization unit is arranged upstream of the optical parametric amplifier 32, but another gain equalization unit is arranged downstream of the optical parametric amplifier 32.

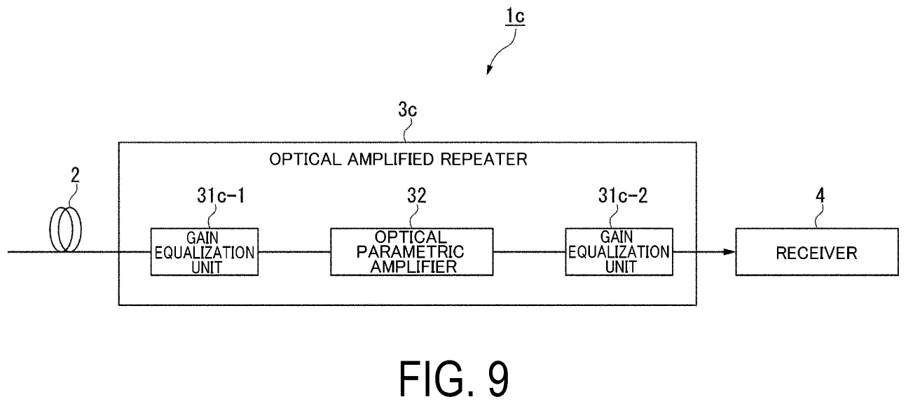

FIG. 9 is a diagram showing an example of the configuration of an optical transmission system 1c in the third embodiment. The optical transmission system 1c is a system that transmits optical signals. The optical transmission system 1c includes a transmission line 2, an optical amplified repeater 3c, and a receiver 4. The optical amplified repeater 3c includes a gain equalization unit 31c-1, a gain equalization unit 31c-2, and an optical parametric amplifier 32.

The allocation of the attenuation amount of each gain equalization unit 31c is determined in advance based on the deterioration amount of the optical signal-to-noise ratio and the loss spectrum of the transmission line 2. Here, the deterioration of the optical signal-to-noise ratio is determined in advance based on the gain saturation characteristics (gain spectrum characteristics) of the optical parametric amplifier 32 and the amount of optical power attenuation by the gain equalization unit 31c-1 upstream of the optical parametric amplifier 32.

In the gain equalization in the gain equalization unit 31c-1, the amount of attenuation is suppressed so that the sum of the linear penalty due to the deterioration of the optical signal-to-noise ratio and the nonlinear penalty due to the increase in the power of the optical signal input to the optical parametric amplifier 32 is minimized. The linear penalty due to the gain equalization can be estimated by adding the amount of attenuation caused by the gain equalization in the gain equalization unit 31c-1 to the noise figure of the optical parametric amplifier 32.

The gain equalization unit 31c-2 shapes the power spectrum of the optical signal output from the optical parametric amplifier 32 so as to become a transmission spectrum determined in advance for the optical parametric amplifier 32. This makes it possible to obtain optimal transmission characteristics.

Note that attenuation due to gain equalization in the gain equalization unit 31c-2 downstream of the optical parametric amplifier 32 does not affect the noise figure. For example, when a channel with an attenuation of 3 dB caused by gain equalization by the gain equalization unit 31c-1 is amplified by the optical parametric amplifier 32 with a noise figure of 5 dB, the effective noise figure of the optical amplified repeater 3c is 8 dB. Based on this effective noise figure, it is possible to estimate a linear penalty.

Unlike the gain spectrum of an amplifier such as an erbium-doped fiber amplifier, the gain spectrum of the optical parametric amplifier 32 is constant in the non-saturation region and does not depend on the power spectrum of the input optical signal. For this reason, the attenuation spectrum (attenuation characteristics) in the gain equalization unit 31c may be fixed rather than variable according to the wavelength.

When the optical parametric amplifier 32 is used as a wavelength converter, the spectrum is inverted due to wavelength conversion, so the gain equalization unit 31c performs gain equalization based on an attenuation spectrum having a spectrum inversion result with characteristics opposite to those of the gain spectrum.

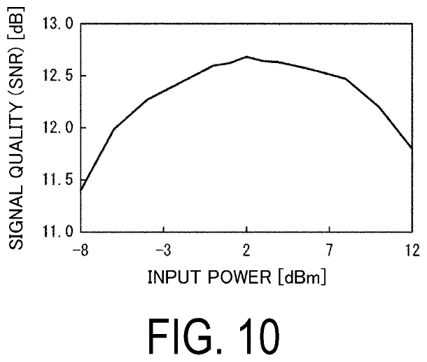

FIG. 10 is a diagram showing an example of the relationship between the power of the optical signal before amplification (power of the input optical signal) and the signal quality of the amplified optical signal, taking into account the deterioration of the optical signal-to-noise ratio due to gain equalization in the third embodiment. The horizontal axis of FIG. 10 indicates the power (input power) of the optical signal input to the single optical parametric amplifier 32. The vertical axis of FIG. 10 indicates the signal quality of the amplified optical signal, taking into account the deterioration of the optical signal-to-noise ratio due to gain equalization.

The relationship between the power of the input optical signal and the signal quality can be calculated by adding the nonlinear penalty (for example, the penalty of the signal quality illustrated in FIG. 5) measured in advance and the linear penalty. The amount of gain equalization (the power of the optical signal input to the optical parametric amplifier) can be optimized based on the calculated relationship.

In a region where the power of the input optical signal is weak, the linear penalty is dominant compared to the nonlinear penalty. Therefore, in a region where the power of the input optical signal is weak, the signal quality improves as the power of the input optical signal increases. In addition, since the nonlinear penalty gradually increases, the signal quality peaks at a certain input power, and the signal quality deteriorates in a region where the input power is exceeded.

As described above, the gain equalization unit 31c-1 is arranged upstream of the optical parametric amplifier 32. The gain equalization unit 31c-2 is arranged downstream of the optical parametric amplifier 32. This makes it possible to suppress nonlinear signal distortion caused by gain saturation in the optical parametric amplifier 32.

### Fourth Embodiment

In the fourth embodiment, the main difference from the second and third embodiments is that the optical parametric amplifier has a plurality of gain equalization units. In the fourth embodiment, the differences from the second and third embodiments will be mainly described.

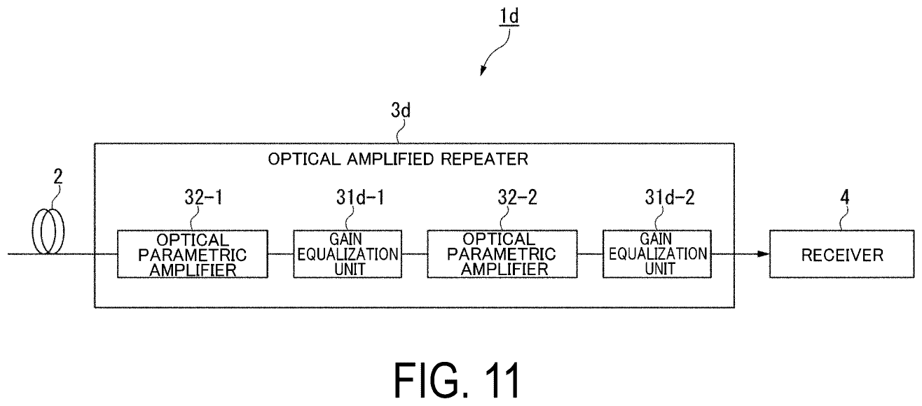

FIG. 11 is a diagram showing an example of the configuration of an optical transmission system 1d in the fourth embodiment. The optical transmission system 1d is a system for transmitting optical signals. The optical transmission system 1d includes a transmission line 2, an optical amplified repeater 3d, and a receiver 4. The optical amplified repeater 3d includes a gain equalization unit 31d-1, a gain equalization unit 31d-2, an optical parametric amplifier 32-1, and an optical parametric amplifier 32-2.

The allocation of the attenuation of each gain equalization unit 31d in the optical amplified repeater 3d is determined in advance based on the deterioration of the optical signal-to-noise ratio and the transmission loss spectrum of the transmission line 2. Here, the amount of deterioration of the optical signal-to-noise ratio is determined in advance based on the gain saturation characteristics (gain spectrum characteristics) of the optical parametric amplifier 32-2 and the amount of optical power attenuation by the upstream gain equalization unit 31d-1.

As described above, the gain equalization unit 31d-1 is arranged downstream of the optical parametric amplifier 32-1. The optical parametric amplifier 32-2 is arranged downstream of the gain equalization unit 31d-1. The gain equalization unit 31d-2 is arranged downstream of the optical parametric amplifier 32-2. This makes it possible to suppress nonlinear signal distortion caused by gain saturation in the optical parametric amplifier 32.

### Fifth Embodiment

In the fifth embodiment, the main difference from the first to fourth embodiments is that distributed Raman amplification (DRA) is used to suppress the deterioration of the optical signal-to-noise ratio. In the fifth embodiment, the differences between the first to fourth embodiments will be mainly described.

In distributed Raman amplification, Raman pumped light is input to a transmission line (transmission medium). The waveform band of the Raman pumped light is about 100 nm shorter than the wavelength band of the optical signal to be amplified. As a result, the optical signal is amplified while being transmitted through the transmission line. By adjusting the arrangement wavelength of the Raman pumped light, it is possible to adjust the gain spectrum (adjustment spectrum) in distributed Raman amplification. In other words, it is possible to shape the gain spectrum (adjustment spectrum) in Raman amplification using distributed Raman amplification so that it has the opposite characteristics (complementary characteristics) to the characteristics of the gain spectrum of the optical parametric amplifier 32 at the end of the transmission line 2.

Here, when the power spectrum of the input optical signal is shaped by distributed Raman amplification, the power spectrum of the input optical signal is only amplified by the distributed Raman amplification and is not attenuated. As a result, it is possible to maximize the power of the optical signal output from the optical parametric amplifier 32 without diminishing the optical signal-to-noise ratio. Furthermore, even if a band cannot be used for transmission by a single optical parametric amplifier 32 due to the low amplification gain of the optical parametric amplifier 32, such a band can be used for transmission by using the gain of Raman amplification in combination. Furthermore, amplified repeating in a wider band is possible.

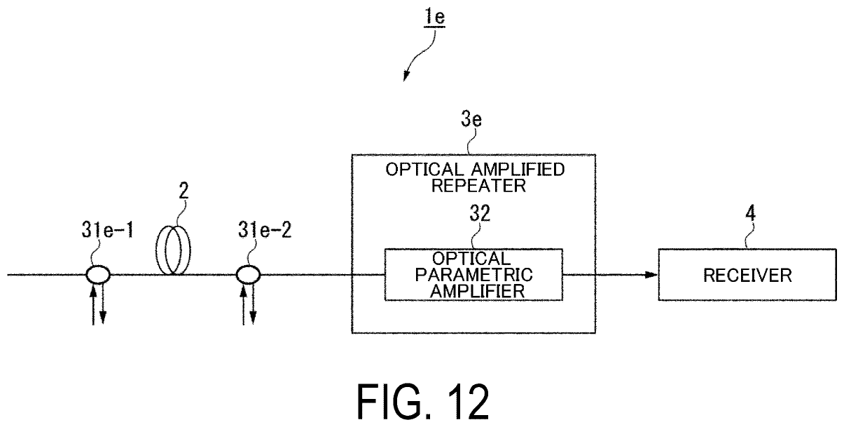

FIG. 12 is a diagram showing an example of the configuration of an optical transmission system le in the fifth embodiment. The optical transmission system le is a system for transmitting optical signals. The optical transmission system le includes a transmission line 2, an optical amplified repeater 3e, and a receiver 4. The transmission line 2 includes, for example, an optical fiber and one or more gain equalization units 31e. The gain equalization unit 31e is a Raman amplifier (distributed Raman amplifier). The optical amplified repeater 3e includes one or more optical parametric amplifiers 32. The optical amplified repeater 3e may include one or more gain equalization units 31e.

Raman pumped light is input to the transmission line 2. The gain spectrum of Raman amplification varies depending on the number of wavelengths and the wavelength arrangement of the Raman pumped light. The wavelength of the Raman pumped light is determined so that the power spectrum of the input optical signal at the end of the transmission line 2 and the gain spectrum of the optical parametric amplifier 32 are complementary.

The number of wavelengths and the wavelength arrangement of the Raman pumped light are determined in advance so that when the optical parametric amplifier 32 further amplifies the Raman-amplified optical signal, the power spectrum of the optical signal output from the optical parametric amplifier 32 approaches an optimal transmission spectrum determined based on the transmission loss spectrum of the transmission line or the like. The number of wavelengths and the wavelength arrangement of the Raman pumped light may be determined in advance so that the power spectrum of the optical signal output from the optical parametric amplifier 32 is flat. The gain equalization of the optical parametric amplifier 32 is performed by Raman amplification using such Raman pumped light.

As described above, the gain equalization unit 31e adjusts the power spectrum of the optical signal by distributed Raman amplification. As a result, even if gain equalization by attenuation is not performed upstream of the optical parametric amplifier 32, it is possible to suppress nonlinear signal distortion caused by gain saturation in the optical parametric amplifier 32. Since the amount of attenuation may be small, it is possible to suppress the deterioration of the optical signal-to-noise ratio. In addition, since the optical signal is amplified by Raman amplification in the region where the gain of the optical parametric amplifier 32 is low, it is possible to expand the band that can be used for transmission.

### Sixth Embodiment

In the sixth embodiment, the main difference from the fourth and fifth embodiments is that lumped Raman amplification (LRA: Lump Raman Amplification) is used in order to suppress the deterioration of the optical signal-to-noise ratio. In the sixth embodiment, the differences from the fourth and fifth embodiments will be mainly described.

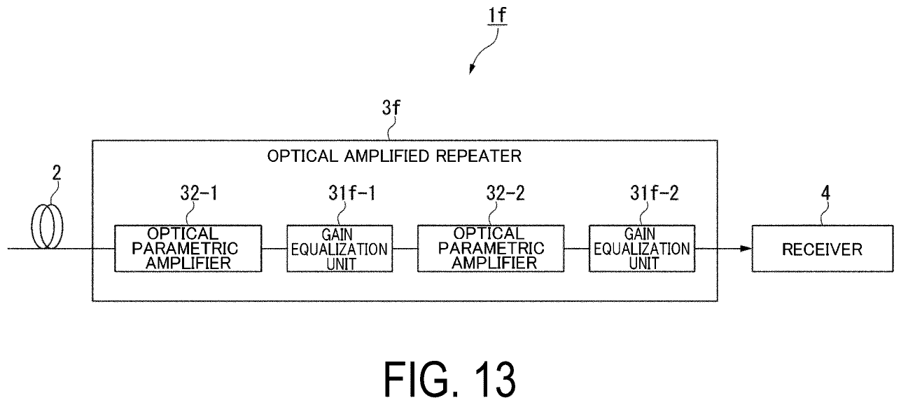

FIG. 13 is a diagram showing an example of the configuration of an optical transmission system 1f in the sixth embodiment. The optical transmission system 1f is a system that transmits an optical signal. The optical transmission system 1f includes a transmission line 2, an optical amplified repeater 3f, and a receiver 4.

The gain equalization unit 31f is a Raman amplifier (lumped Raman amplifier). The gain equalization unit 31f is used as a gain equalizer in the optical parametric amplifier 32. The optical amplified repeater 3f includes one or more optical parametric amplifiers 32 and one or more gain equalization units 31f. In FIG. 13, the optical amplified repeater 3f includes two optical parametric amplifiers 32 and two gain equalization units 31f. In the optical amplified repeater 3f, the optical parametric amplifiers 32 and the gain equalization units 31f are, for example, alternately connected in cascade.

In this way, in the optical amplified repeater 3f, the gain equalization unit 31d-1 is replaced with the gain equalization unit 31f-1 (lumped Raman amplifier), and the gain equalization unit 31d-2 is replaced with the gain equalization unit 31f-2 (lumped Raman amplifier) in comparison with the optical amplified repeater 3d of the fourth embodiment. Any gain equalization unit in each of the optical transmission systems of the first to fourth embodiments can be replaced with the gain equalization unit 31f (lumped Raman amplifier).

In the gain equalization unit 31f, the wavelength (frequency) of the pumped light is appropriately arranged on the frequency axis. Thereby, the relationship between the gain spectrum by the two gain equalization units 31f and the gain spectrum by the two optical parametric amplifiers 32 becomes complementary.

As described above, the gain equalization unit 31f adjusts the power spectrum of the optical signal by lumped Raman amplification. This makes it possible to suppress nonlinear signal distortion caused by gain saturation in the optical parametric amplifier 32.

In each of the optical transmission systems of the first to fourth embodiments, an attenuation spectrum having the opposite characteristics (gradient) to the characteristics of the gain spectrum of the optical parametric amplifier 32 is realized by using a gain equalization unit that attenuates the power spectrum of the input optical signal. That is, in each of the optical transmission systems of the first to fourth embodiments, the power spectrum of the optical signal is shaped using the attenuation gain of the gain equalization unit. In contrast to this, in the sixth embodiment, the power spectrum of the optical signal is shaped using the amplification gain of the gain equalization unit (lumped Raman amplifier), so that the deterioration of the optical signal-to-noise ratio is small.

### Hardware Configuration

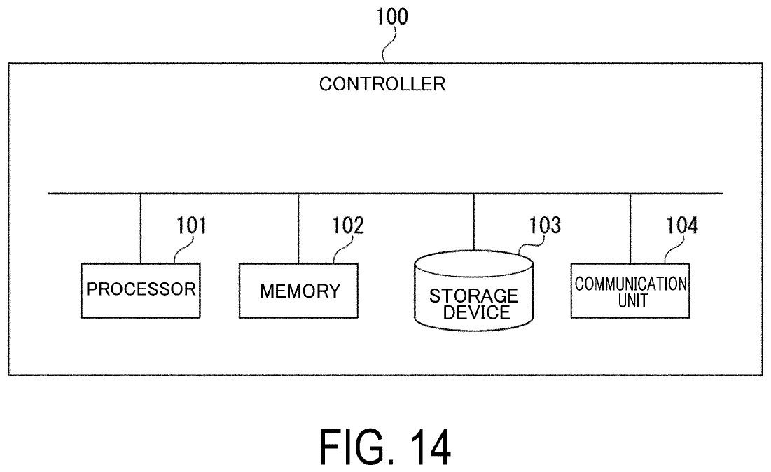

FIG. 14 is a diagram showing an example of the hardware configuration of a controller 100 of the optical amplified repeater in each embodiment. The hardware configuration example of the controller 100 corresponds to the hardware configuration example of the controller of the optical amplified repeater in each embodiment. The controller 100, for example, executes the parameter design of the optical amplified repeater. The controller 100, for example, adjusts the temperature of the optical amplified repeater.

The controller 100 is realized as software by a processor 101 such as a CPU (Central Processing Unit) executing a program stored in a storage device 103 having a non-volatile recording medium (non-transitory recording medium) and a memory 102. The program may be recorded in a computer-readable recording medium. The computer-readable recording medium is, for example, a portable medium, such as a flexible disk, a magneto-optical disk, a ROM (Read Only Memory), or a CD-ROM (Compact Disc Read Only Memory), or a non-transitory recording medium, such as a storage device like a hard disk or a solid state drive (SSD) built into a computer system. The communication unit 104 executes a predetermined communication process.

The controller 100 may be realized using hardware (accelerator) including an electronic circuit (electronic circuit or circuitry) using, for example, an LSI (Large Scale Integrated circuit), an ASIC (Application Specific Integrated Circuit), a PLD (Programmable Logic Device), or an FPGA (Field Programmable Gate Array).

Although the embodiment of the present invention has been described in detail with reference to the drawings, a specific configuration is not limited to this embodiment, and design within the scope of the gist of the present invention and the like are included.

### Industrial Applicability

The present invention is applicable to optical transmission systems.

### REFERENCE SIGNS LIST

1a, 1b, 1c, 1d, 1e, 1f Optical transmission system
2 Transmission Line
3a, 3b, 3c, 3d, 3e, 3f Optical amplified repeater
4 Receiver
31a, 31b, 31c, 31d, 31e, 31f Gain equalization unit
32 Optical parametric amplifier
101 Processor
102 Memory
103 Storage device
104 Communication unit
321 Monitor
322 Band demultiplexer
323 Polarization demultiplexer
324 Pumped light multiplexer
325 Nonlinear optical medium
326 Pumped light demultiplexer
327 Polarization multiplexer
328 Band multiplexer
329 Monitor

1. An optical amplified repeater comprising:
a gain equalizer that adjusts a power spectrum of an optical signal based on an adjustment spectrum having characteristics complementary to characteristics of a gain spectrum;
an amplifier that amplifies the power spectrum adjusted based on the adjustment spectrum based on the gain spectrum.

2. An optical transmission system comprising:
a gain equalizer that adjusts a power spectrum of an optical signal based on an adjustment spectrum having characteristics complementary to characteristics of a gain spectrum;
an amplifier that amplifies the power spectrum adjusted based on the adjustment spectrum based on the gain spectrum; and
a receiver that performs demodulation processing on the optical signal or phase conjugate light of the amplified power spectrum.

3. The optical transmission system according to claim 2, wherein
the adjustment spectrum has constant characteristics regardless of the power spectrum and bandwidth of the optical signal input to the gain equalizer.

4. The optical transmission system according to claim 2, wherein
the gain equalizer adjusts the power spectrum of the optical signal by distributed Raman amplification or lumped Raman amplification.

5. An optical amplified repeating method executed by an optical transmission system, the method comprising:
adjusting a power spectrum of an optical signal based on an adjustment spectrum having characteristics complementary to characteristics of a gain spectrum;
amplifying the power spectrum adjusted based on the adjustment spectrum based on the gain spectrum; and
performing demodulation processing on the optical signal or phase conjugate light of the amplified power spectrum.
